(19) United States
(12) Patent Application Publication
(10) Pub. No.: US 2010/0044286 A1
(43) Pub. Date: Feb. 25, 2010

(54) Water-Purification Pretreatment System

(76) Inventors: Takashi Menju, Kawasaki-shi (JP); Mii Fukuda, Tokyo (JP); Yasushi Yamamoto, Yokohama-shi (JP); Kazuyoshi Aoki, Yokohama-shi (JP); Takeshi Matsushiro, Yokohama-shi (JP); Futoshi Kurokawa, Tokyo (JP); Atsushi Yukawa, Tokyo (JP); Tokusuke Hayami, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/540,530

(22) Filed: Aug. 13, 2009

(30) Foreign Application Priority Data
Aug. 22, 2008 (JP) P2008-214269

(51) Int. Cl. C02F 1/38; B01D 21/30; B04C 5/00; B04C 5/24

(52) U.S. Cl. 210/96.1; 210/512.1; 210/198.1; 210/138

(57) ABSTRACT

A water-purification pretreatment system removes raw water of suspended solids heavier in specific gravity than water before a water-purification treatment of raw water taken from a water source and the system includes a liquid cyclone configured for raw water to inflow thereto and to be swirled inside thereof to separate from raw water suspended solids heavier in specific gravity tan water, an inflow line connected with the liquid cyclone for raw water to be supplied to the liquid cyclone and configured for raw water being supplied to swirl inside the liquid cyclone, and an outflow line configured for raw water having suspended solids separated therefrom to outflow as pretreated water from the liquid cyclone, allowing for a reduced load on a treatment of solid suspended solids as a water treatment for water purification plants.

### CROSS REFERENCE TO RELATED APPLICATIONS

The present application claims the benefit of priority under 35 U.S.C. §119 to Japanese Patent Application No. 2008-214269, filed on Aug. 22, 2008, the entire contents of which are incorporated herein by reference.

### BACKGROUND OF THE INVENTION

1. Field of Art

The present invention relates to a water-purification pretreatment system adapted to remove suspended solids having larger specific gravities than water before water purification treatments in a water treatment system or water purification plants.

2. Description of Relevant Art

In water treatment, raw water contains suspended solids, turbid components, etc, which are disposed of mainly by flocculation by use of inorganic flocculants, followed by water purification treatments such as a gravitational setting in a sedimentation tank, sand filtration, and membrane filtration.

FIG. 1 illustrates a water treatment system 100 as a general example making use of flocculation sedimentation. There is a water intake plant installed at a river as a water source, which employs a water intake pump 1 for drawing raw water from the river. Raw water drawn by the intake pump 1 is sent trough a water intake line 2 to a water intake well 3, where it is stored. After that, raw water is sent from the intake well 3 to a sand basin 4, where it removes sand that has a fast settling rate, and thereafter, it is sent by a water transmission pump 5 through a headrace line 6 to a water reservoir well 7. Subsequently, using a reservoir water pump 8, raw water is sent from the reservoir well 7 to a fast agitation basin 9.

At the fast agitation basin 9, raw water is agitated, while having a pH adjuster, sodium hypochlorite, and flocculant or the like added thereto, and sent to a flocculation basin 10. At the flocculation basin 10, solid materials suspended in raw water are caused to clump together into floc, and raw water containing floc is sent to a sedimentation basin 11, where floc settles down. Then, raw water is sent to a sand filtration basin 12, where it is sand-filtrated, and enters a water purification basin 13, where it is chlorinated by addition of a chlorinator, before distribution of water.

In the flocculation sedimentation, suspended solids contained in raw water are clustered as floc by flocculants, and floc of suspended solids heavier in specific gravity than water is settled down to take the supernatant as treated water, whereby raw water is separated into solids (suspended solids) and treated water. In recent years, the sedimentation basin 11 is sometimes implemented as a sedimentation tank with a reduced capacity, or to improve the separation efficiency, by using an inclined plate or inclined pipes for enhancement in speed of treatment.

The sand filtration is employed for treatment of water having relatively low concentrations of suspended solids, such as treated water after flocculation sedimentation. For instance, at the sand filtration basin 12, raw water is conducted through, from above, a sand-filed tank, where suspended solids are caught by sand particles, whereby purified liquid is taken as treated water.

The membrane filtration conducts raw water through a nitration membrane having fine-diameter holes, such as a microfiltration membrane or ultrafiltration membrane, to thereby separate suspended solids to condense. In order for a filtration membrane to survive longer in membrane filtration, there is a technique employing a cyclone in pretreatment (refer to Japanese Patent Application Laid-Open Publication No. 2004-313900).

In the a water treatment system 100 discussed above with reference to FIG. 1, excepting such suspended solids as having large particle diameters like sand and settling down in the sand basin 4, most suspended solids were carried by raw water being sent from the reservoir well to water-purification treatment processes. Therefore, even if large in particle diameter, suspended solids contained in raw water were to be removed in post treatments for water purification, such as flocculation sedimentation, sand filtration, and membrane filtration, thus constituting a load on a respective water-purification treatment, when treating raw water containing much suspended solids.

For instance, in the flocculation sedimentation, the rate of flocculant addition depends on a turbidity of raw water, so the amount of flocculant used for flocculation sedimentation increases in proportion to a quantity of incoming suspended solids. The amount of produced sludge also increases in proportion to the amount of flocculant used. Therefore, depending on the quantity of in suspended solids, times required for treatments as well as a cost of flocculant and a cost for sludge disposal were increased, as an issue.

In particular, in red times, the turbidity of river or the like might come up to as high as 1,000 degrees or more, causing a treatment in a clarifying process to fall behind. Such an overloading might be coped with an interrupted water intake, resulting in an unstable water purification treatment, as an issue.

The present invention has been devised in view of such issues, and it is an object of the present application to provide a water-purification pretreatment system adapted for a reduced load on a treatment of solid suspended solids as a water treatment for water purification plants.

### SUMMARY OF THE INVENTION

According to an aspect of the present invention, a water-purification pretreatment system is adapted to remove raw water of suspended solids heavier in specific gravity than water before a water-purification treatment of raw water taken form a water sour, the system comprising at least one liquid cyclone configured for raw water to inflow thereto and to be swirled inside thereof to separate from raw water suspended solids heavier in specific gravity than water, an inflow line connected with the liquid cyclone for raw water to be supplied to the liquid cyclone and configured for raw water being supplied to swirl inside the liquid cyclone, and an outflow line configured for raw water having suspended solids separated therefrom to outflow as pretreated water from the liquid cyclone.

### BRIEF DESCRIPTION OF THE DRAWINGS

FIG. 1 is an explanatory flow diagram of a general example of water treatment system.

FIG. 2 is an explanatory flow diagram of a water treatment system including a water-purification pretreatment system according to a first embodiment of the present invention.

FIG. 3A is a perspective view of a liquid cyclone of the water treatment system of FIG. 2, and FIG. 3B, a cross sectional view of the same.

FIG. 4 is an explanatory flow diagram of a water treatment system including a water-purification pretreatment system according to a second embodiment of the present invention.

FIG. 5 is an explanatory flow diagram of a water treatment system including a water-purification pretreatment system according to a third embodiment of the present invention.

FIG. 6 is an explanatory flow diagram of a water treatment system including a water-purification pretreatment system according to a further embodiment of the present invention.

FIG. 7 is a graph of histograms of particle diameters of suspended solids in normal raw water and high-turbid raw water.

FIG. 8 is an explanatory flow diagram of a water treatment system including a water-purification pretreatment system according to a fifth embodiment of the present invention.

FIG. 9 is an explanatory flow diagram of a water treatment system including a water-purification pretreatment system according to a sixth embodiment of the present invention.

FIG. 10 is a graph of histograms of particle diameters of suspended solids in normal raw water and flocculant-added raw water.

FIG. 11 is an explanatory flow diagram of a water treatment system including a water-purification pretreatment system according to a seventh embodiment of the present invention.

FIG. 12 is a graph of a relationship between a tubidity of raw water and a flocculant adding rate.

FIG. 13 is an explanatory flow diagram of a water treatment system including a water-purification pretreatment system according to an eighth embodiment of the present invention.

FIG. 14 is a graph of a relationship between a streaming current and a flocculant adding rate; and a relationship between a turbidity of supernatant after sedimentation and the flocculant adding rate.

FIG. 15 is an explanatory flow diagram of a water treatment system including a water-purification pretreatment system according to a ninth embodiment of the present invention.

### DETAILED DESCRIPTION OF THE EMBODIMENTS

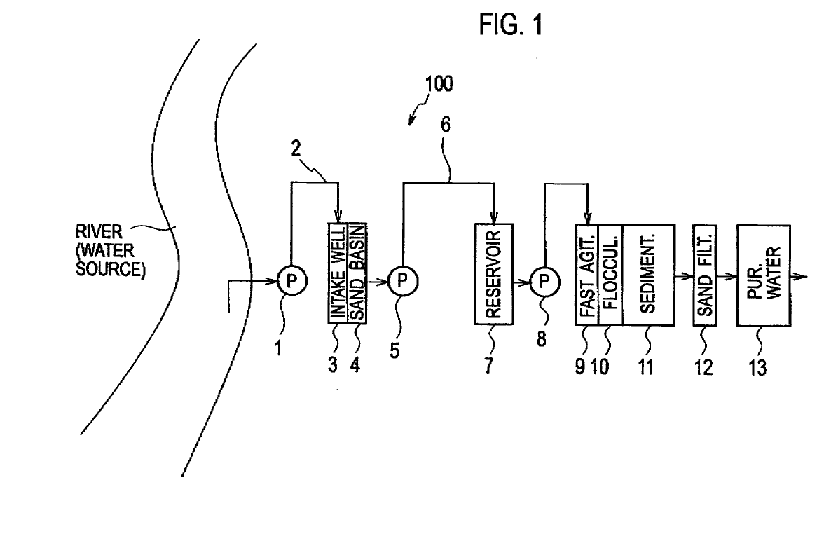

There will be described water-purification pretreatment systems for water treatment systems according to embodiments of the present invention, with reference to associated drawings. Those water-purification pretreatment systems are each adapted to separate suspended solids heavier in specific gravity than water from raw water as a target of water purification treatments such as flocculation sedimentation and sand filtration, before entering these water purification treatments, to reduce loads on them in such a water treatment system 100 as discussed above with reference to FIG. 1. It is now noted that the settling rate of solid particles is proportional to a square of an average particle diameter, and the larger the particle diameter is the greater the settling rate becomes. In the embodiments, like elements are designated by like reference characters in drawings, to omit redundancy. In regard of the general example in FIG. 1, as well, like elements are designated by like reference characters.

### First Embodiment

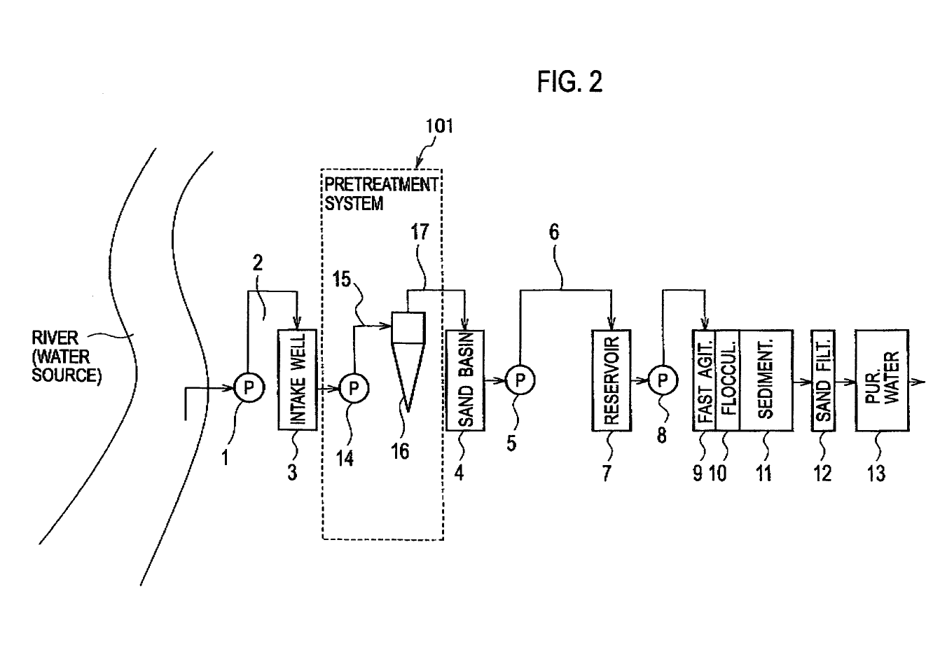

Description is now me with reference to FIG. 2, of a water-purification pretreatment system 101 according to a first embodiment of the present invention. According to the first embodiment, the water-purification pretreatment system 101 is installed as part of a water treatment system 100 in which raw water is drawn from a river as a water source, by using a water intake pump 1, to undergo water purification treatments such as in a fast agitation basin 9, a flocculation basin 10, a sedimentation basin 11, and a sand filtration basin 13, before water distribution, as having been discussed with reference to FIG. 1.

In the water-purification pretreatment system 101 according to the first embodiment, raw water stored in a water intake well 3 is supplied by a pump 14 for pretreatment, through a water inlet or inflow line 15, to a liquid cyclone 16 as a pretreatment apparatus. The liquid cyclone 16 separates, from raw water, suspended solids such as sand particles heavier in specific gravity than water. Raw water having removed such suspended solids is sent through a water outlet or outflow line 17 to a sand basin 4. That is, according to the first embodiment, the water-purification pretreatment system 101 is installed for interconnection between the intake well 3 and the sand basin 4 in the water treatment system 100 of FIG. 1.

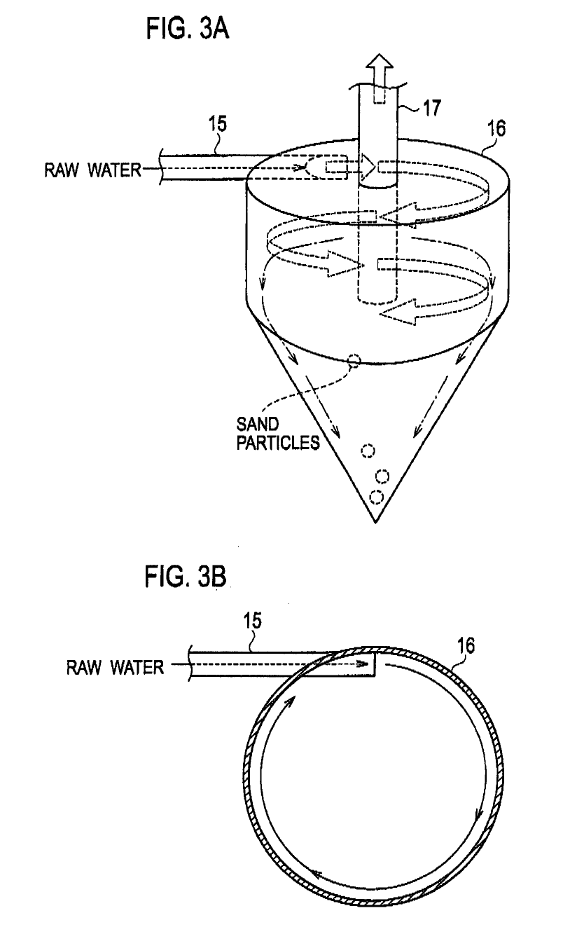

As illustrated in FIGS. 3A and 3B, the liquid cyclone 16 is formed in a general cyclone shape with a cylindrical drum, of which a top portion has an inflow pipe as a connection end of the inflow line 15 tangentially inserted inside a wall thereof, so that incoming liquid is swirled collision-free along the wall inside. For the liquid cyclone 16, incoming from the intake well 3 is raw water containing suspended solids, of which swirling streams have centrifugal forces acting thereon, whereby suspended solids such as sand particles different in specific gravity from raw water are settled out thereof, being forced to spin down along the wall, so that suspended solids are separated from raw water. Suspended solids as spun down are discharged through a connection end of a solids discharge line, i.e., a solids discharge pipe (not shown) opening at a converged lower end of a cone portion as lower part of the liquid cyclone 16. Raw water as having removed suspended solids is sent to the sand basin 4, through a proximal end of an outflow line 17, i.e., a pretreated water outflow, outlet, or discharge pipe extending along an axis of the drum portion as upper part of the liquid cyclone 16.

According to the first embodiment, a water-purification pretreatment system 101 is configured to separate suspended solids such as sand particles heavier in specific gravity than water (and relatively large in particle size) from raw water before water purification treatments such as flocculation sedimentation. Therefore, according to the first embodiment, a water-purification pretreatment system 101 is adapted for use to lighten burdens for separation of suspended solids at subsequent water purification treatments.

According to the first embodiment, lightened burdens on water purification treatments by use of a water-purification pretreatment system 101 afford to prevent water intake suspensions such as due to an overload, thus allowing for water purification treatments to be stabilized.

According to the first embodiment a water-purification pretreatment system 101 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

### Second Embodiment

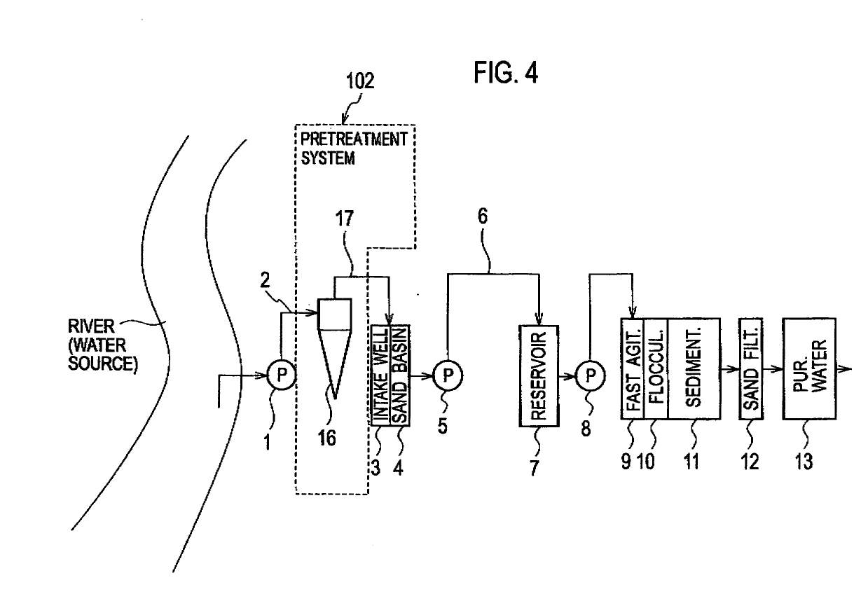

Description is now made with reference to FIG. 4, of a water-purification pretreatment system 102 according to a second embodiment of the present invention. According to the second embodiment, the water-purification pretreatment system 102 is installed for interconnection between a water intake pump 1 and a water intake well 3 in a water treatment system 100 of FIG. 1, and includes a liquid cyclone 16 configured to separate from raw water suspended solids heavier in specific gravity than water, and an outflow line 17 configured for raw water having suspended solids separated therefrom to outflow from the liquid cyclone 16.

According to the second embodiment, a water-purification pretreatment system 102 is configured to separate suspended solids such as sand particles heavier in specific gravity than water (and relatively large in particle size) from raw water before water purification treatments such as flocculation sedimentation. Therefore, according to the second embodiment, a water-purification pretreatment system 102 is adapted for use to lighten burdens for separation of suspended solids at subsequent water purification treatments.

According to the second embodiment lightened burdens on water purification treatments by use of a water-purification pretreatment system 102 afford to prevent water intake suspensions such as due to an overload, thus allowing for water purification treatments to be stabilized.

According to the second embodiment a water-purification pretreatment system 102 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

Further, according to the second embodiment, in a water-purification pretreatment system 102, raw water is drawn by a water intake pump 1 to supply to a liquid cyclone 16, employing a water intake line 2 as an inflow line, rendering a pump 14 unnecessary for pretreatment, thus allowing for implementation with a simplified configuration relative to the water-purification pretreatment system 101 according to the first embodiment.

### Third Embodiment

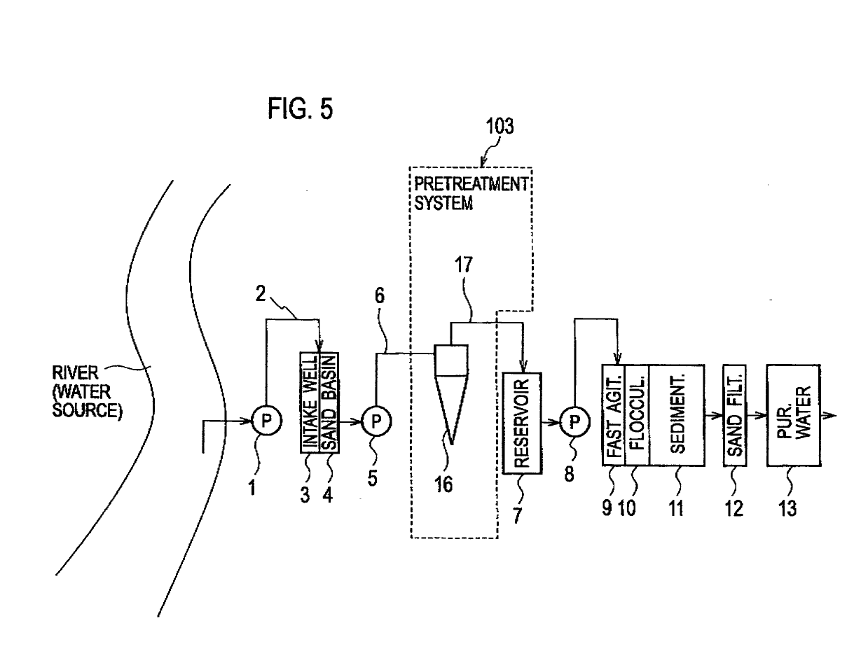

Description is now made with reference to FIG. 5, of a water-purification pretreatment system 103 according to a third embodiment of the present invention. According to the third embodiment, the water-purification pretreatment system 103 is installed for interconnection between a water transmission pump 5 and a water reservoir well 7 in a water treatment system 100 of FIG. 1, and includes a liquid cyclone 16 configured to separate from raw water suspended solids heavier in specific gravity than water, and an outflow line 17 configured for raw water having suspended solids separated therefrom to outflow from the liquid cyclone 16.

According to the third embodiment, a water-purification pretreatment system 103 is configured to separate suspended solids such as sand particles heavier in specific gravity than water (and relatively large in particle size) from raw water before water purification treatments such as flocculation sedimentation. Therefore, according to the third embodiment, a water-purification pretreatment system 103 is adapted for use to lighten burdens for separation of suspended solids at subsequent water purification treatments.

According to the third embodiment, lightened burdens on water purification treatments by use of a water-purification pretreatment system 101 afford to prevent water intake suspensions such as due to an overload, thus allowing for water purification treatments to be stabilized.

According to the third embodiment, a water-purification pretreatment system 103 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

Further, according to the third embodiment, in a water-purification pretreatment system 103, a water transmission pump 5 is used to supply raw water to a liquid cyclone 16, employing a headrace line 6 as an inflow line, rendering a pump 14 unnecessary for pretreatment, thus allowing for implementation with a simplified configuration relative to the water-purification pretreatment system 101 according to the first embodiment.

### Fourth Embodiment

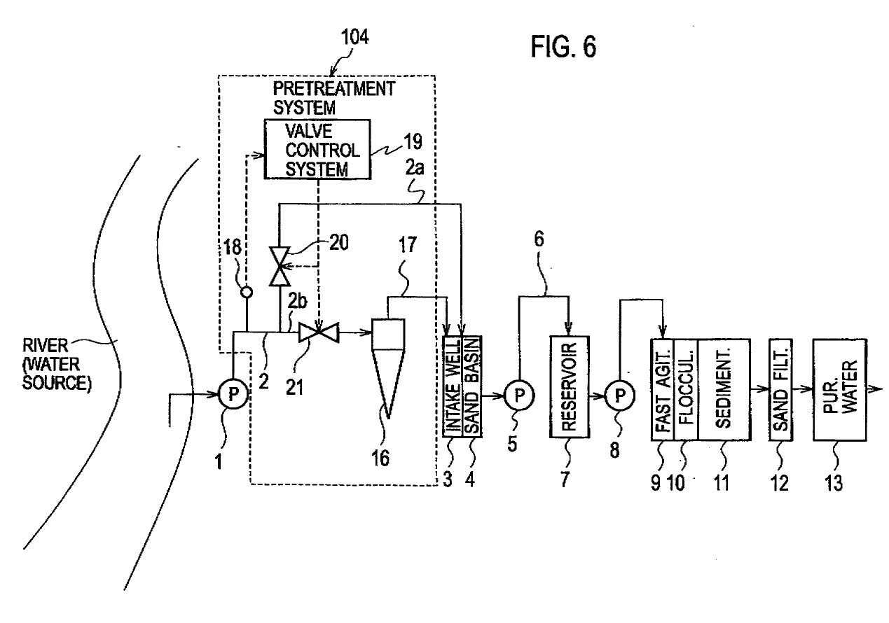

Description is now made with reference to FIG. 6, of a water-purification pretreatment system 104 according to a fourth embodiment of the present invention. According to the fourth embodiment, the water-purification pretreatment system 104 is installed for interconnection between a water intake pump 1 and a water intake well 3 in a water treatment system 100 of FIG. 1, and includes a liquid cyclone 16 configured to separate from raw water suspended solids heavier in specific gravity than water, and an outflow line 17 configured for raw water having suspended solids separated therefrom to outflow from the liquid cyclone 16. It further includes a turbidity meter 18 configured to measure a turbidity of raw water drawn by the intake pump 1, and a valve control system 19 configured for control of first and second valves 20 and 21 in accordance with the turbidity as measured. The water-purification pretreatment system 104 has a water intake line 2 branched on the way into an intake well-side line 2a for supplying raw water to the intake well 3, and a cyclone-side line 2b for supplying raw water to the liquid cyclone 16. The intake well-side line 2a has the first valve 20 installed therein. The cyclone-side line 2b has the second valve 21 installed therein.

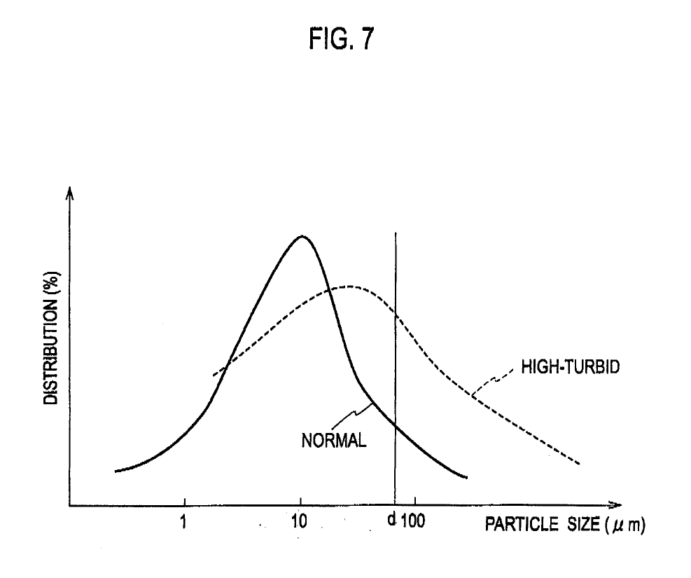

The valve control system 19 is configured to determine whether or not the turbidity measured by the turbidity meter 18 is equal to or higher than a preset threshold (for instance, 100 degrees). FIG. 7 illustrates distributions of particle diameters of solids contained in normal raw water and high-turbid raw water. The liquid cyclone 16 has a performance for separation from liquid of suspended solids within a specified particle diameter range above a small diameter. Assuming a particle diameter of suspended solids separable from raw water as d μm, normal raw water has, as illustrated in FIG. 7, a low content of suspended solids d μm or more in particle diameter. To the contrary, high-turbid raw water may well contain suspended solids of larger particle diameters by a high proportion, with a commensurate high content of solids d μm or more in particle diameter.

Normal raw water contains a small quantity of suspended solids separable by the liquid cyclone 16. To this point, the larger the solid particle diameter is the higher the spin-down rate becomes, so high-turbidity raw water contains a relatively large quantity of suspended solids separable by the liquid cyclone 16. Therefore, for high-tubidity raw water, the liquid cyclone 16 is available as an implement for efficient water treatment to separate sand particles. Accordingly, the valve control system 19 has a threshold set thereon to define a turbidity range for efficient separation of sand particles by the liquid cyclone 16.

The valve control system 19 is adapted for control, as the turbidity measured by the turbidity meter 18 is lower than the threshold, to open the first valve 20 and close the second valve 21, so that raw water is supplied to the intake well 3. On the other hand, the valve control system 19 is adapted for control, as the turbidity measured by the turbidity meter 18 is equal to or higher than the threshold, to dose the first valve 20 and open the second valve 21, so that raw water is supplied to the liquid cyclone 16.

According to the fourth embodiment, a water-purification pretreatment system 104 is adapted to selectively send to the liquid cyclone 16 such a state of raw water that contains suspended solids separable by the liquid cyclone 16 by a relatively large proportion.

Therefore, according to the fourth embodiment, a water-purification pretreatment system 104 is adapted for use to lighten burdens for separation of suspended solids at subsequent water purification treatments. Moreover, according to the fourth embodiment, lightened burdens on water purification treatments by use of a water-purification pretreatment system 104 afford to prevent water intake suspensions such as due to an overload, thus allowing for water purification treatments to be stabilized. Further, according to the fourth embodiment, a water-purification pretreatment system 104 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

It is noted that, the water-purification pretreatment system 104 according to the fourth embodiment may be install for interconnection in the water treatment system 100, not simply between the water intake pump 1 and the water intake well 3, but also, among others, after the water intake well 3 or after the sand basin 4.

### Fifth Embodiment

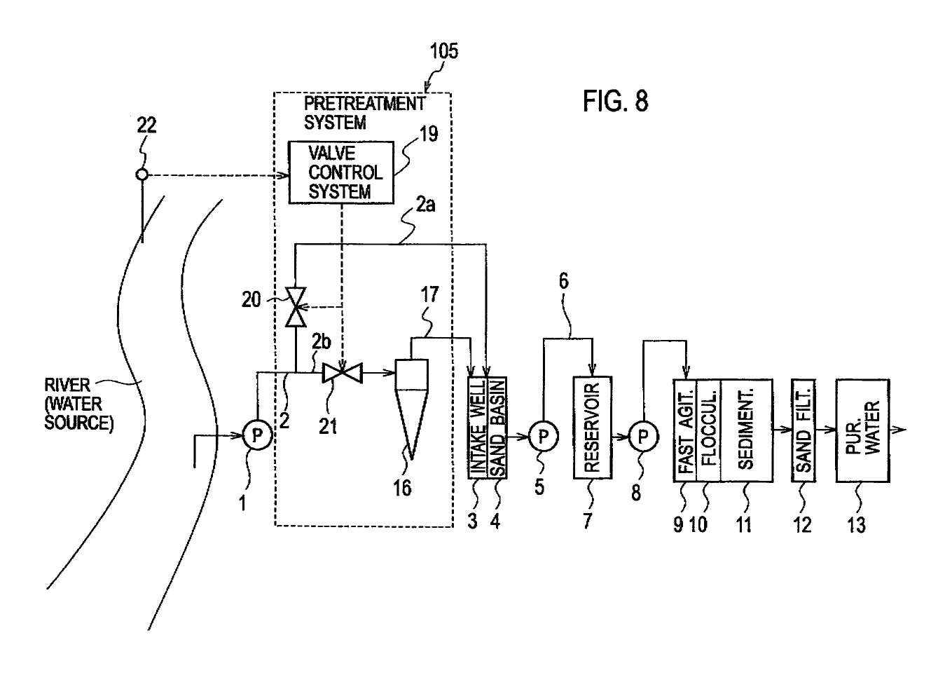

Description is now made with reference to FIG. 8, of a water-purification pretreatment system 105 according to a fifth embodiment of the present invention. According to the fifth embodiment, the water-purification pretreatment system 105 is different from the water-purification pretreatment system 104 according to the fourth embodiment discussed above with reference to FIG. 6, in that it has no turbidity meter 18 measuring a turbidity of raw water drawn by the intake pump 1, but includes a valve control system 19 that is configured to input thereto a turbidity measured by a turbidity meter 22 at a water source, and control first and second valves 20 and 21 in accordance with the turbidity measured by the turbidity meter 22.

The valve control system 19 is configured to determine whether or not the turbidity input from the turbidity meter 22 is equal to or higher than a preset threshold (for instance, 100 degrees), and is adapted for control, as the input turbidity is lower than the threshold, to open the first valve 20 and close the second valve 21, so that raw water is supplied to the intake well 3. On the other hand, the valve control system 19 is adapted for control as the turbidity input from the turbidity meter 22 is equal to or higher than the present threshold, to close the first valve 20 and open the second valve 21, so that raw water is supplied to the liquid cyclone 16.

According to the fifth embodiment, a water-purification pretreatment system 105 is adapted to selectively send to the liquid cyclone 16 such a state of raw water that contain suspended solids separable by the liquid cyclone 16 by a relatively large proportion.

Therefore, according to the fifth embodiment, a water-purification pretreatment system 105 is adapted for use to lighten burdens for separation of suspended solids at subsequent water purification treatments. Moreover, according to the fifth embodiment, lightened burdens on water purification treatments by use of a water-purification pretreatment system 104 afford to prevent water intake suspensions such as due to an overload, thus allowing for water purification treatments to be stabilized. Further, according to the fifth embodiment, a water-purification pretreatment system 105 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

According to the fifth embodiment, a water-purification pretreatment system 105 is adapted for control of valves 20 and 21 in accordance with a turbidity measured at a water source, thus allowing for earlier control of the valves 20 and 21 relative to controlling the valves 20 and 21 after a measurement of a turbidity of raw water drawn by a water intake pump 1.

It is noted that, the water-purification pretreatment system 105 according to the fifth embodiment may be installed for interconnection in the water treatment system 100, not simply between the water intake pump 1 and the water intake well 3, but also, among others, after the water intake well 3 or after the sand basin 4.

### Sixth Embodiment

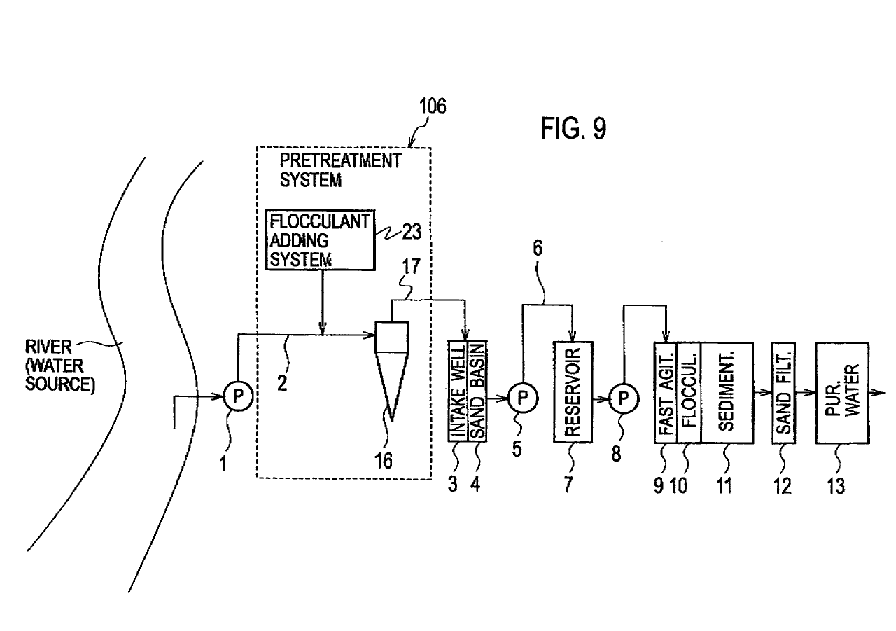

Description is now made with reference to FIG. 9, of a water-purification pretreatment system 106 according to a six embodiment of the present invention. According to the sixth embodiment, the water-purification pretreatment system 106 is installed for interconnection between a water intake pump 1 and a water intake well 3 in a water treatment system 100 of FIG. 1, and includes a liquid cyclone 16 configured to separate from raw water suspended solids heavier in specific gravity than water, and an outflow line 17 configured for raw water having suspended solids separated therefrom to outflow from the liquid cyclone 16. It further includes a flocculant adding system 23 configured for addition of flocculant to raw water.

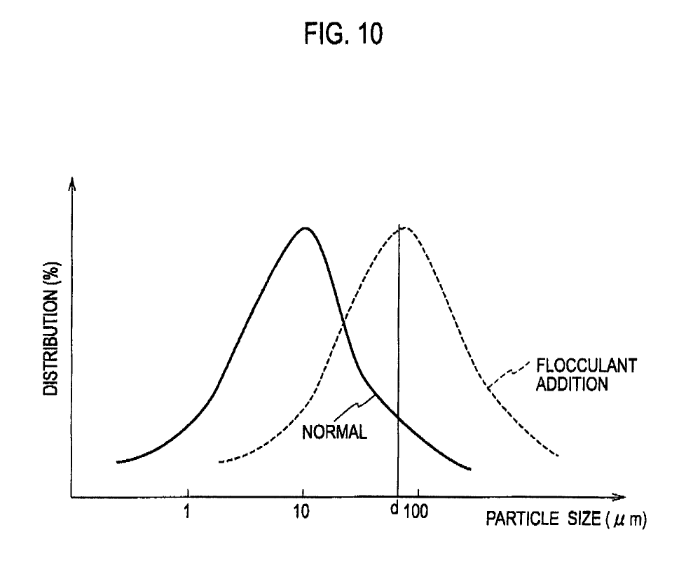

The flocculant adding system 23 adds a flocculant to raw water for flocculation of solids contained in raw water. FIG. 10 illustrates distributions of particle diameters of solids contained in normal raw water and flocculant-added raw water. Assuming a particle diameter of suspended solids separable from raw water as d μm, normal raw water has, as illustrated in FIG. 10, a low content of suspended solids d μm or more in particle diameter. In this regard, flocculation of suspended solids causes suspended solids to cluster with increased particle diameters, so flocculant-added raw water has an increased content of solids d μm or more in particle diameter, as well. Normal raw water contains a small quantity of suspended solids separable by the liquid cyclone 16. To this point the larger the solid particle diameter is the higher the spin-down rate becomes, so high-turbidity raw water contains a relatively large quantity of suspended solids separable by the liquid cyclone 16.

It is note that the amount of flocculant added by the flocculant adding system 23 should be as necessary to separate (roughly take out) no more than suspended solids of relatively large particle diameters, and is not required to be a lot. In this connection, the water treatment system includes flocculation sedimentation as a necessary subsequent treatment. For the subsequent flocculation sedimentation, there may well be a subsequent addition of flocculant for flocculation of suspended solids that have not been separated by the liquid cyclone 16.

The flocculant used for addition by the flocculant adding system 23 may be a high molecular flocculant. High molecular flocculants have strong adhesive power relative to PAC (polyaluminum chloride), but they are soluble in water, so excessive addition may give a residue in water. However, the binding power may well be applicable, so far as the amount is controlled to separate (roughly take out) no more than suspended solids of relatively large particle diameters, as described.

According to the sixth embodiment, a water-purification pretreatment system 106 employs a combination of a flocculant adding system 23 and a liquid cyclone 16 for reduction of suspended solids heavier in specific gravity than water (and relatively large in particle size) in raw water, to lighten burdens on subsequent water purification treatments. Moreover, according to the sixth embodiment, lightened burdens on water purification treatments by use of a water-purification pretreatment system 106 afford to prevent water intake suspensions such as due to an overload, thus allowing for water purification treatments to be stabilized. Further, according to the sixth embodiment, a water-purification pretreatment system 106 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

It is noted that, the water-purification pretreatment system 106 according to the sixth embodiment may be instead for interconnection in the water treatment system 100, not simply between the water intake pump 1 and the water intake well 3, but also, among others, after the water intake well 3 or after the sand basin 4.

### Seventh Embodiment

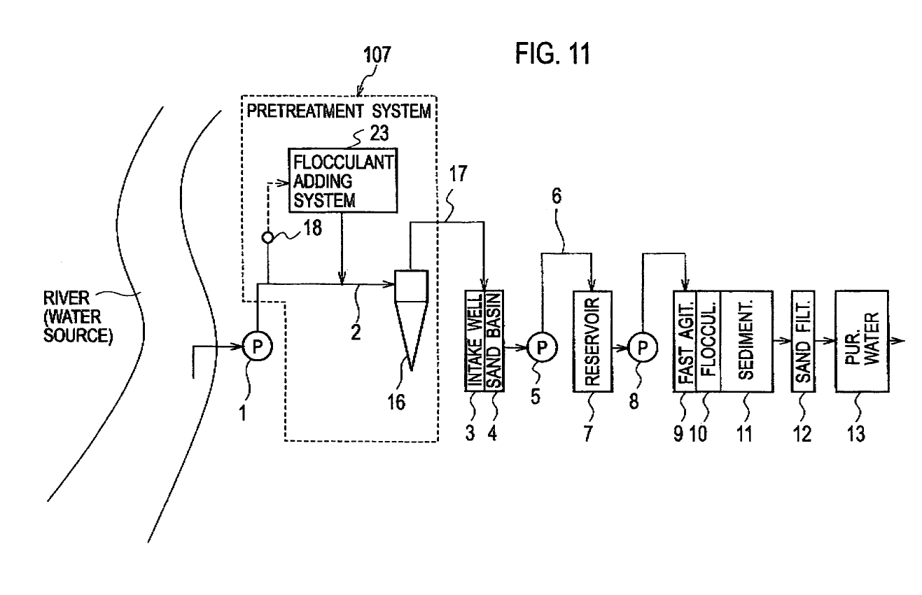

Description is now made with reference to FIG. 11, of a water-purification pretreatment system 107 according to a seventh embodiment of the present invention. According to the seventh embodiment, the water-purification pretreatment system 107 is different from the water-purification pretreatment system 106 according to the sixth embodiment discussed above with reference to FIG. 9, in that it has a turbidity meter 18 measuring a turbidity of raw water drawn by a water intake pump 1. Further, the water-purification pretreatment system 107 includes a flocculant adding system 23 configured for addition of flocculant in accordance with the turbidity measured by the turbidity meter 18.

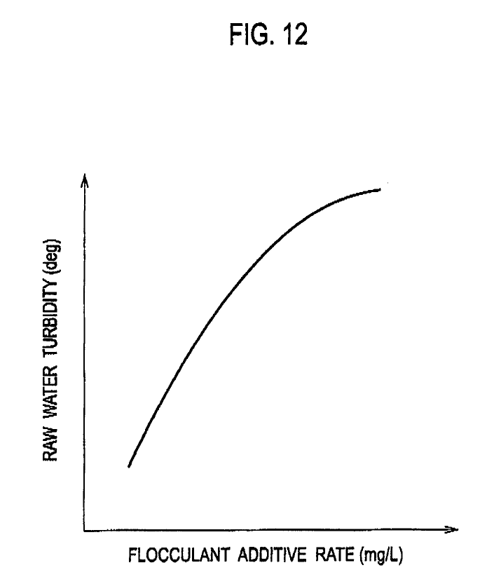

As illustrated in FIG. 12, for addition of flocculant, an optimal amount is determined in accordance with a turbidity of raw water. Therefore, the flocculant adding system 23 has a preset amount of flocculant addition depending on the turbidity, and adapted to add to raw water a amount of flocculant depending on a turbidity measured by the turbidity meter 18.

According to the seventh embodiment, a water-purification pretreatment system 107 employs a combination of a flocculant adding system 23 and a liquid cyclone 16 for reduction of suspended solids heavier in specific gravity than water (and relatively large in particle size) in raw water, to lighten burdens on subsequent water purification treatments. Moreover, according to the seventh embodiment, lightened burdens on water purification treatments by use of a water-purification pretreatment system 107 afford to prevent water intake suspensions such as due to an overload, thus allowing for water purification treatments to be stabilized. Further, according to the seventh embodiment, a water-purification pretreatment system 107 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

According to the seventh embodiment, a water-purification pretreatment system 107 is adapted for use of a feed-forward control to add an amount of flocculant in accordance with a turbidity of raw water, thereby preventing the separation efficiency of suspended solids at the liquid cyclone 16 from turning down due to a shorted addition of flocculant while preventing flocculant from being contained in raw water outflowing from the water-purification pretreatment system 107 due to an excessive addition of flocculant, thus allowing for a stabilized quality of water outflowing from the liquid cyclone 16.

It is noted that, the water-purification pretreatment system 107 according to the seventh embodiment may be installed for interconnection in the water treatment system 100, not simply between the water intake pump 1 and the water intake well 3, but also, among others after the water intake well 3 or after the sand basin 4.

### Eighth Embodiment

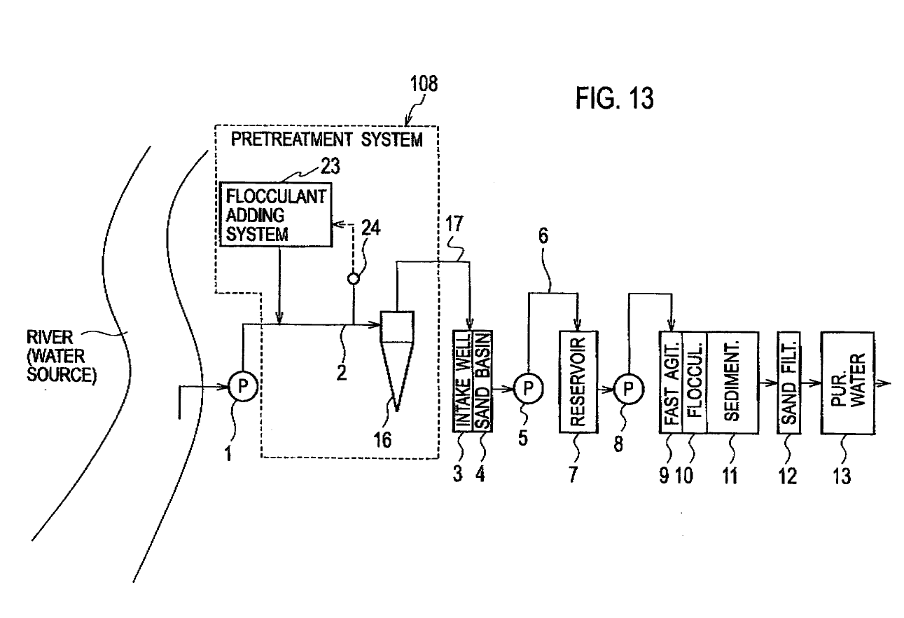

Description is now made with reference to FIG. 13, of a water-purification pretreatment system 108 according to an eighth embodiment of the present invention. According to the eighth embodiment, the water-purification pretreatment system 108 is different from the water-purification pretreatment system 106 according to the sixth embodiment discussed above with reference to FIG. 9, in that it has a streaming current meter 24 measuring a streaming current of raw water after addition of flocculant by a flocculant adding system 23. In the water-purification pretreatment system 108, the flocculant adding system 23 is configured for addition of flocculant in accordance with a streaming current measured by the streaming current meter 24.

For detection of a streaming current, it is possible to indirectly measure zeta potentials of particle surfaces, permitting use of a streaming current for a prediction of a repulsive force between particles being suspended solids to determine an effect of flocculant.

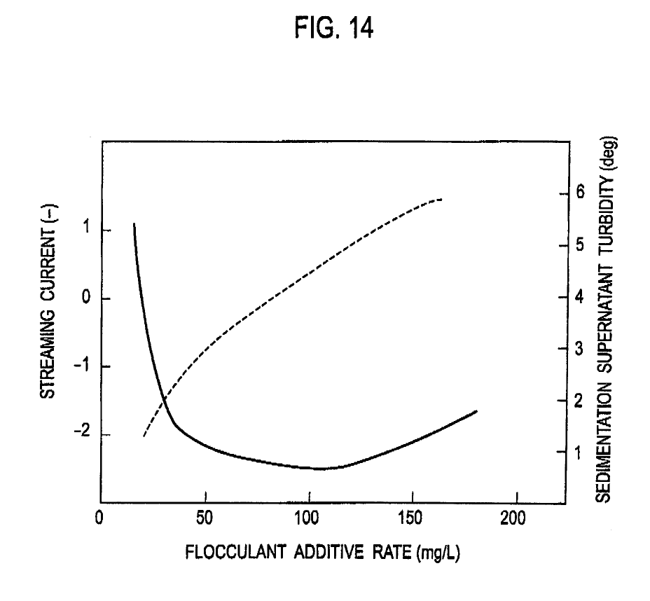

FIG. 14 illustrates an exemplary combination of a relationship between a streaming current and a flocculant adding rate and a relationship between a turbidity of supernatant after sedimentation and the flocculant adding rate. As illustrated in FIG. 14, as the flocculant adding rate is increased up to a prescribed value, the turbidity of supernatant after sedimentation comes down, with an increasing efficiency in separation of suspended solids. However, at excessive high adding rates of flocculant, there appears poor flocculation, with an increased turbidity of supernatant after sedimentation. For a flocculant to be added to raw water by the flocculant adding system 23, the amount has an optimal value, which can be determined from a value of streaming current.

For instance, the flocculant adding system 23 has a preset range of streaming currents defined between a lower or minimal threshold Vmin and an upper or maximal threshold Vmax, whereby it is adapted to determine a current adding rate of flocculant as being optimal for a value of streaming current input from the streaming current meter 24 residing within the range between the lower threshold Vmin and the upper threshold Vmax. However, for any value of streaming current input from the streaming current meter 24 coinciding with or exceeding the upper threshold Vmax, the flocculant adding system 23 determines a current adding rate of flocculant as being excessive, and operates to decrease the adding rate. Further, for any value of streaming current input from the streaming current meter 24 coinciding with or smaller than the lower threshold Vmin, the flocculant adding system 23 determines a current adding rate of flocculant as lacking and operates to increase the adding rate.

According to the eighth embodiment, a water-purification pretreatment system 108 employs a combination of a flocculant adding system 23 and a liquid cyclone 16 for reduction of suspended solids heavier in specific gravity than water (and relatively large in particle size) in raw water, to lighten burdens on subsequent water purification treatments. Moreover, according to the eighth embodiment, lightened burdens on water purification treatments by use of a water-purification pretreatment system 108 afford to prevent water intake suspensions such as due to an overload, thus a allowing for water purification treatments to be stabilized. Further, according to the eighth embodiment, a water-purification pretreatment system 108 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well.

According to the eighth embodiment, a water-purification pretreatment system 108 is adapted for use of a feedback control to add an amount of flocculant in accordance with a streaming current, thereby preventing the separation efficiency of suspended solids at the liquid cyclone 16 from turning down due to a shorted addition of flocculant, while preventing flocculant first being contained in raw water outflowing from the water-purification pretreatment system 108 due to an excessive addition of flocculant, thus allowing for a stabilized quality of water outflowing from the liquid cyclone 16.

It is noted that, the water-purification pretreatment system 108 according to the eighth embodiment may be installed for interconnection in the water treatment system 100, not simply between the water intake pump 1 and the water intake well 3, but also, among others, after the water intake well 3 or after the sand basin 4.

### Ninth Embodiment

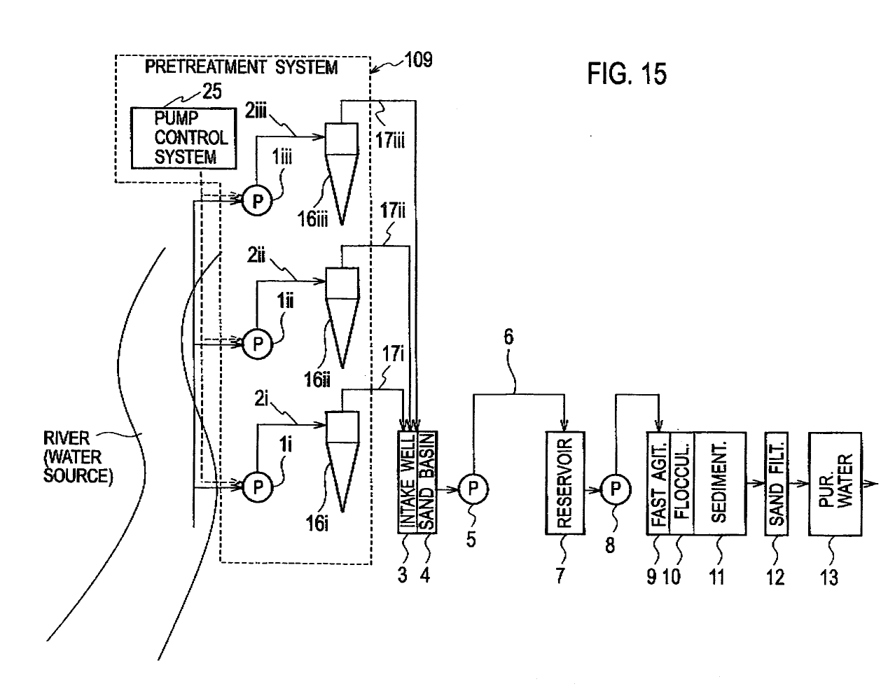

Description is now made with reference to FIG. 15, of a water-purification pretreatment system 109 according to the ninth embodiment of the present invention. According to the ninth embodiment the water-purification pretreatment system 109 is similar to the water-purification pretreatment system 102 according to the second embodiment, while the former has three water intake pumps 1i to 1iii, three inlet or inflow lines 2i to 2iii, three liquid cyclones 16i to 16iii, three outlet or outflow lines 17i to 17iii, and a single pump control system 25.

The is an associated water treatment system 100, which has e.g. a time-dependent variable amount of raw water as a target of treatment so the number of pumps controlled is determined in accordance with the amount of raw water to be treated. The pump controller 25 is adapted to individually control the water intake pumps 1i to 1iii in accordance with preset timing. For instance, it may be preset to control the three pumps in the daytime, and a single pump in the nighttime.

Liquid cyclones are configured to separate solids from raw water subject to a secured constant flow rate. Under a varying water intake flow, provision of a single liquid cyclone would result in supplying the liquid cyclone with a varying flow rate of raw water, which might cause an unstable status of fluid in the liquid cyclone, constituting a difficulty in separation of suspended solids from raw water. To this point, according to the ninth embodiment, the water-purification pretreatment system 109 is not operated so as to change flow rates of raw water to be drawn at the pumps 1i to 1iii, but is adapted for adjustment in number of pumps to be operated to adjust a low rate of raw water to be drawn in accordance with a required water intake flow of the water treatment system 100.

According to the ninth embodiment, a water-purification pretreatment system 109 is adapted for use to lighten burdens on separation of suspended solids in water purification treatments. Moreover, according to the ninth embodiment, lightened burdens on water purification treatments by use of a water-purification pretreatment system 109 afford to prevent water intake suspensions such as due to an overload, thus allowing for water-purification treatments to be stabilized. Further, according to the ninth embodiment a water-purification pretreatment system 109 is adapted for use to provide raw water with a reduced quantity of particles suspended therein, permitting flocculant amounts also to be reduced as necessary for flocculation sedimentation in a subsequent water purification treatment, thus allowing for a reduced amount of sludge to be produced by the flocculation sedimentation, as well. In addition, according to the ninth embodiment, a water-purification pretreatment system 109 is adapted to control the number of pimps to be driven to cope with a variation of water intake flow.

It is noted that, the water-purification pretreatment system 109 according to the ninth embodiment may be installed for interconnection in the water treatment system 100, not simply between the water intake pump 1 and the water intake well 3, but also, among others, after the water intake well 3 or after the sand basin 4. Further, among others, pumps and cyclones are not limited to free in number, and may well be an arbitrary plurality subject to a possible number control operation.

According to the foregoing embodiments, there is an implemented reduced load on a treatment of suspended solids as a water treatment for water purification plants.

While preferred embodiments of the present invention have been described using specific terms, such description is for illustrative purposes, and it is to be understood that changes and variations may be made without departing from the spirit or scope of the following claims.

What is claimed is:

1. A water-purification pretreatment system adapted to remove raw water of suspended solids heavier in specific gravity than water before a water-purification treatment of raw water taken from a water source, the system comprising:
at least one liquid cyclone configured for raw water to inflow thereto and to be swirled inside thereof to separate from raw water suspended solids heavier in specific gravity than water;
an inflow line connected with the liquid cyclone for raw water to be supplied to the liquid cyclone and configured for raw water being supplied to swirl inside the liquid cyclone; and
an outflow line configured for raw water having suspended solids separated therefrom to outflow as pretreated water from the liquid cyclone.

2. The water-purification pretreatment system according to clam 1, further comprising:
a turbidity meter configured to measure a turbidity of raw water to be supplied to the liquid cyclone; and
a controller configured for control, as the turbidity of raw water is equal to or higher than a prescribed value, to supply raw water to the liquid cyclone, and for control, as the turbidity of raw water is lower than the prescribed value, to stop supplying raw water to the liquid cyclone, and conduct raw water as pretreated water for the water-purification treatment.

3. The water-purification pretreatment system according to claim 1, further comprising a controller configured to input thereto a turbidity of raw water of a water source from a turbidity meter measuring the turbidity of raw water of the water source, and configured for control, as the turbidity of raw water as input is equal to or higher than a prescribed value, to supply raw water to the liquid cyclone, and for control, as the turbidity of raw water as input is lower than the prescribed value, to stop supplying raw water to the liquid cyclone, and conduct raw water as pretreated water for the water-purification treatment.

4. The water-purification pretreatment system according to claim 1, further comprising a flocculant adder to add to raw water a flocculant for flocculation of suspended solids.

5. The water-purification pretreatment system according to claim 4, further comprising:
a turbidity meter configured to measure a turbidity of raw water to be supplied to the liquid cyclone; and
a controller configured for control of the flocculant adder to supply raw water with the flocculant by an amount depending on the turbidity of raw water measured by the turbidity meter.

6. The water-purification pretreatment system according to claim 4, further comprising:
a streaming current meter configured to measure a streaming current of pretreated water outflowing from the liquid cyclone; and
a controller configured for control of the flocculant adder to supply raw water with the flocculant by an amount depending on the streaming current of pretreated water measured by the streaming current meter.

7. The water-purification pretreatment system according to claim 1, further comprising:
a plurality of pumps configured to supply a plurality of liquid cyclones with raw water; and
a controller is adapted to individually control the plurality of pumps in accordance with preset timings.
